(19) United States
(12) Patent Application Publication
(10) Pub. No.: US 2026/0099498 A1
(43) Pub. Date: Apr. 9, 2026

(54) CONVERSATIONAL ASSISTANT FOR REAL-TIME COOKING GUIDANCE

(71) Applicant: Paul Paturi, Alpharetta, GA (US)

(72) Inventor: Paul Paturi, Alpharetta, GA (US)

(21) Appl. No.: 19/274,124

(22) Filed: Jul. 18, 2025

Related U.S. Application Data
(60) Provisional application No. 63/703,964, filed on Oct. 6, 2024.

(51) Int. Cl. G06F 16/2457; G06N 20/00; G10L 15/22

(52) U.S. Cl. CPC G06F 16/24575; G06N 20/00; G10L 15/22

(57) ABSTRACT

The disclosure is directed to a computer Implemented method for providing real time cooking guidance to a user for one or a plurality of cooking recipes including providing voice input or text input information to the computer from the user, wherein the voice input is converted to text input with a natural language processor, the voice input or text input information to the computer including user profile information, recipe selection, kitchen resources, ingredients, time constraints, and number of servings. Providing recipe guidance by the computer for one or more recipes including: providing a recipe ingredient list and providing step by step cooing instructions to the user for the one or more recipes including step by step cooking instructions, time constraints, and reminders.

### CROSS REFERENCE TO RELATED APPLICATIONS

This application claims priority to U.S. application No. 63/703,964 filed on Oct. 6, 2024, which is herein incorporated by reference in its entirety.

### BACKGROUND

### Technical Field of the Invention

The present invention is directed to the field of AI assistants for food preparation and recipes.

### Description of the Related Art

Many people face challenges in the kitchen, from understanding complex recipes to following step-by-step instructions. Existing cooking computer applications often provide basic recipe collections or static tips but lack an interactive element. A need exists for a cooking assistant that can engage users in natural dialogue and interface, offering tailored advice and real-time support while cooking. This assistant must ensure users have prepared all necessary ingredients before cooking and offer the flexibility to manage single or multiple recipes simultaneously.

### SUMMARY DISCLOSURE OF THE INVENTION

The disclosure is directed to a computer Implemented method for providing real time cooking guidance to a user for one or a plurality of cooking recipes including providing voice input or text input information to the computer from the user, wherein the voice input is converted to text input with a natural language processor, the voice input or text input information to the computer including user profile information, recipe selection, kitchen resources, ingredients, time constraints, and number of servings. Providing recipe guidance by the computer for one or more recipes including: providing a recipe ingredient list, and providing step by step cooing instructions to the user for the one or more recipes including step by step cooking instructions, time constraints, and reminders.

Other features and aspects will be apparent from the following detailed description, the drawings, and the claims.

### BRIEF DESCRIPTION OF THE DRAWINGS

FIG. 1 shows an embodiment of the input layer of the disclosure.

FIG. 2 shows an embodiment of the NLP Processing of the disclosure.

FIG. 3 shows an embodiment of recipe processing and coordination of the disclosure.

FIG. 4 shows an embodiment of an Adaptive Learning System of the disclosure.

FIG. 5 shows an embodiment of an Output Generation Layer of the disclosure.

FIG. 6 show example output.

FIG. 7 shows an embodiment.

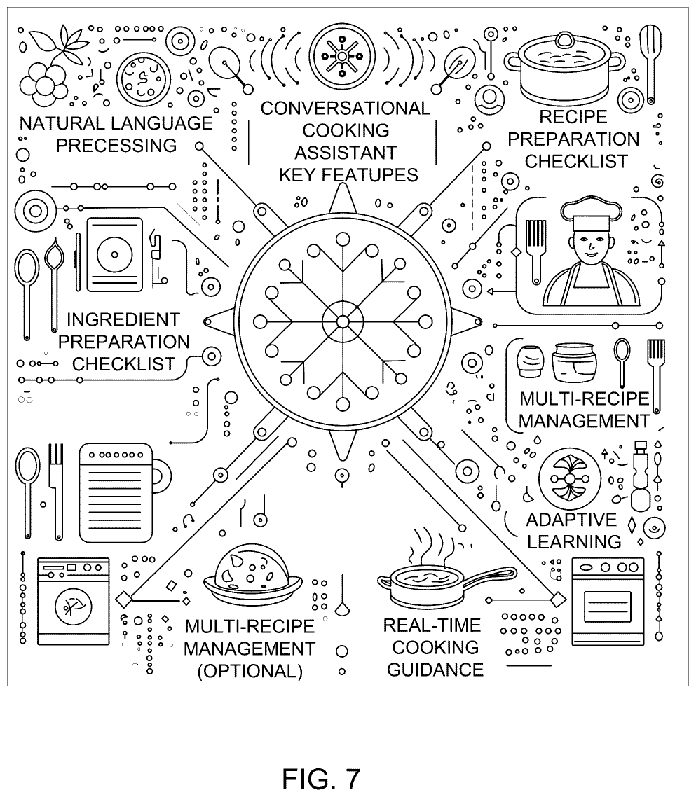

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

The invention is directed to an Artificial Intelligence (AI) conversational cooking assistant that utilizes advanced natural language processing (NLP) and machine learning to provide real-time guidance for cooking food. Key features include the ability to optionally manage multiple recipes simultaneously and an ingredient preparation checklist that ensures users gather all necessary components before cooking begins. This comprehensive approach enhances the cooking experience by minimizing interruptions and streamlining the process.

The architecture includes a Natural Language Processing (NLP) Engine trained to understand culinary terminology and user commands, enabling seamless interaction during cooking. The engine supports voice and text input, allowing users to engage with the assistant in a way that feels most comfortable. The AI assistant interprets user input in real time, allowing for back-and-forth dialogue. Users can confirm that all ingredients are prepared and ready before proceeding to the cooking steps. The NLP engine uses contextual awareness to respond accurately, adjusting to variations in user requests and clarifying any ambiguities. The assistant with machine learning integration learns from each user interaction, optimizing guidance for each recipe based on whether the user is focusing on one or multiple dishes. Over time, the assistant adapts to user preferences, suggesting recipes based on past interactions and adjusting cooking times based on the user's experience level.

Before starting any recipe, the assistant can generate an ingredient preparation checklist, i.e., a list of all necessary ingredients, allowing users to gather everything they need in advance. This feature includes optional reminders for items that may be commonly forgotten.

The assistant has multilingual support and can interact with users in multiple languages, allowing for a broader user base and enhancing accessibility. Users can choose their preferred language at the beginning of their session or switch languages seamlessly during the interaction.

Coordinated cooking allows users to prepare a full meal with multiple recipes, receiving real-time prompts for each dish if desired. The assistant provides timing cues to ensure that all components of the meal are ready simultaneously, enhancing the overall cooking experience.

Before cooking, users can ask the assistant to provide a complete list of ingredients needed for their chosen recipe(s), ensuring they are well-prepared. The assistant can check pantry inventory if integrated with smart home devices, reminding users of items they may need to restock.

Adaptive suggestions are another feature. For example, if users do not have a specific ingredient, the assistant can offer substitutes or adjust the recipe based on available items. This flexibility encourages creativity in the kitchen and reduces food waste.

The disclosure thus provides a method for providing real-time cooking guidance, with the option for simultaneous cooking of multiple recipes, through dynamic interaction using natural language processing and contextual awareness. The assistant can manage the timing and order of instructions to ensure efficient workflow during cooking. A conversational cooking assistant capable of managing ingredient checklists for single or multiple recipes, offering step-by-step instructions tailored to user preferences and ensuring a smooth cooking process. The assistant includes reminders for commonly forgotten items and provides support in multiple languages, making it accessible to a wider audience.

A machine learning system is provided that adapts to user preferences and past interactions, optimizing recipe suggestions based on individual cooking habits and skill levels. This system includes the ability to learn from user feedback, further refining its recommendations and instructional clarity over time. The system includes a feature that enables users to confirm the readiness of all ingredients before starting the cooking process, thereby enhancing user preparedness, and improving the overall cooking experience.

The invention includes a Central Node and a Conversational Cooking Assistant. Branches/Features include Natural Language Processing which captures user queries and provides responses. The assistant can include an ingredient preparation checklist which generates a list of required ingredients before cooking starts. The Assistant also includes an optional Multi-Recipe Management module which allows users to cook multiple recipes simultaneously. Real-Time Cooking Guidance provides step-by-step instructions and timing alerts. Adaptive Learning learns user preferences and optimizes suggestions over time. User Interactions shows arrows connecting user actions (like asking for a recipe) to the assistant's responses (like providing instructions or ingredient lists).

### Architecture

The conversational cooking assistant employs a multi-layered architecture with three primary embodiments for natural language processing, integrated with adaptive learning systems and novel multi-recipe coordination algorithms.

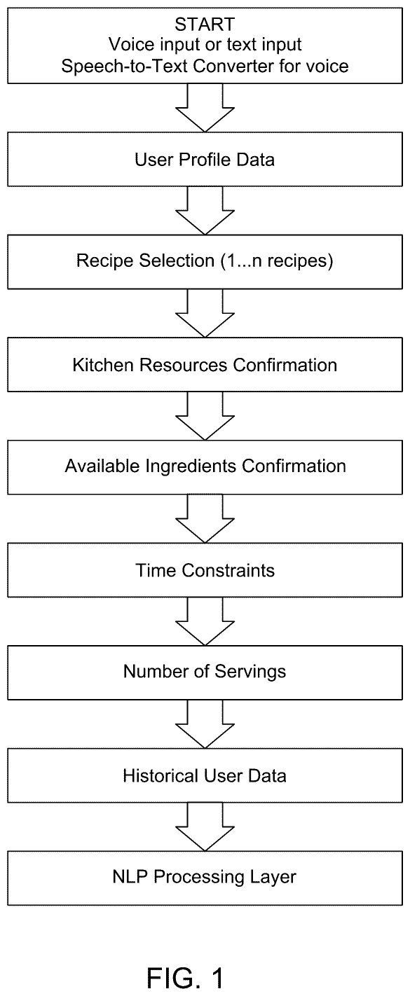

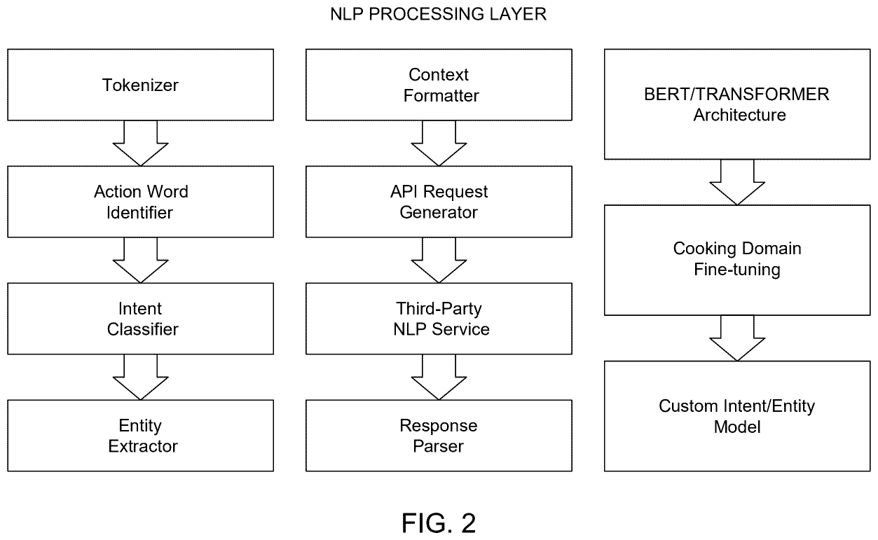

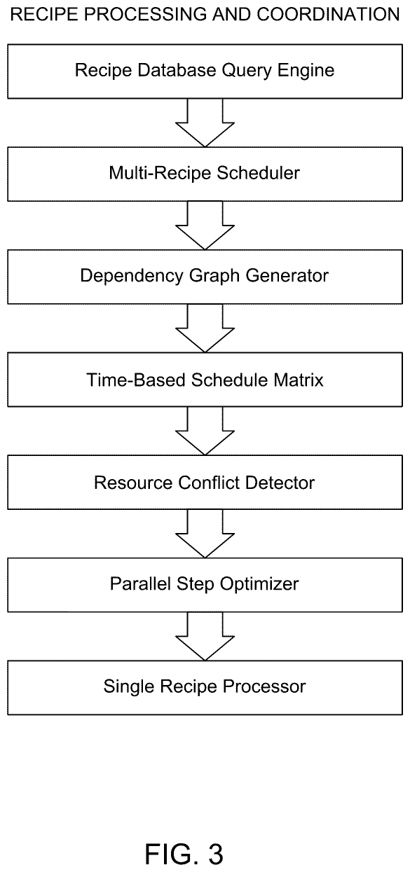

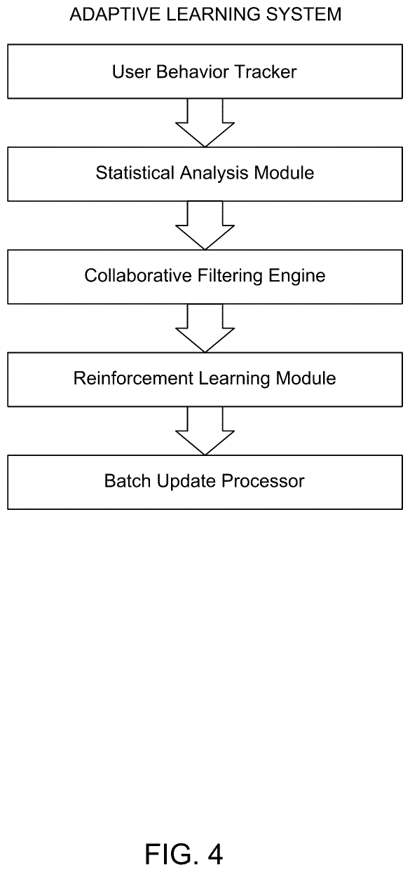

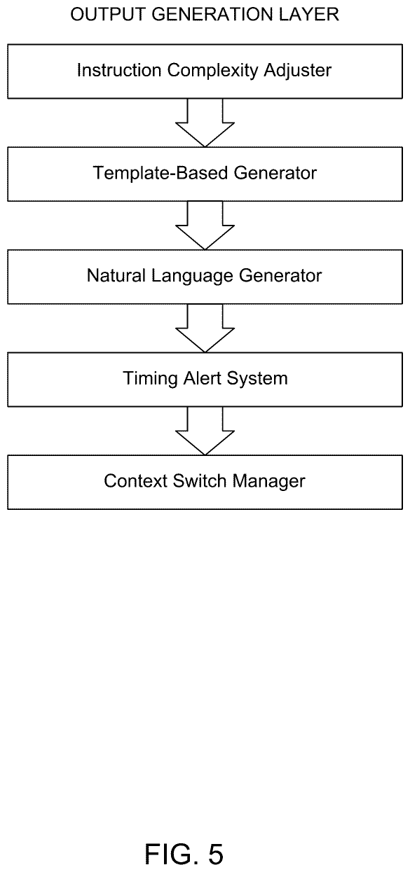

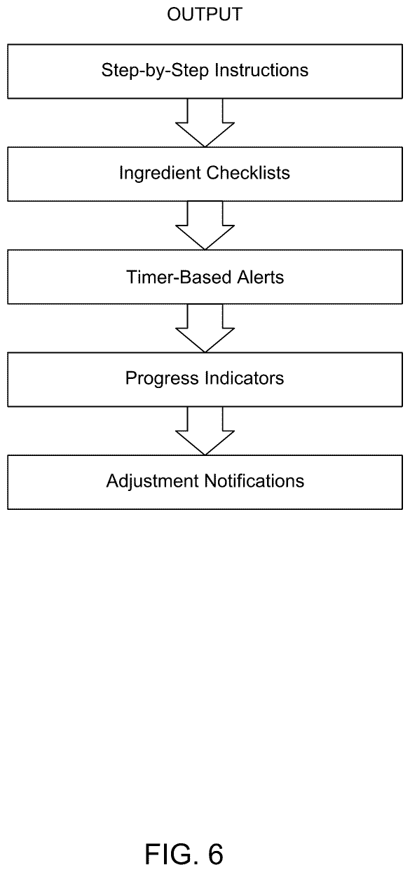

System Components include an input processing layer (FIG. 1); Natural Language Understanding (3 Embodiments) (FIG. 2); Recipe Database Integration (FIG. 3); Multi-Recipe Scheduling Engine (FIG. 3); Adaptive Learning System (FIG. 4); and Output Generation Layer (FIGS. 5 and 6).

It should noted that in each of the figures and flow charts the steps may be performed in an order other than that shown. The order of steps shown in FIGS. 1 through 6 are exemplary and not the only way the processes can be performed. For example, in FIG. 1, in embodiments, the steps could be performed in practically any order. One of ordinary skill in the art would recognize that the exact order of steps shown is not required. The order of steps can thus be performed in any order that accomplishes the objective of Natural Language Understanding, Recipe Database Integration, Multi-Recipe Scheduling Engine, Adaptive Learning, and Output Generation.

The conversational cooking assistant comprises a multi-layered architecture implementing natural language processing, adaptive machine learning, and novel scheduling algorithms. The system processes user inputs through one of three NLP embodiments, matches intents to a curated recipe database, and generates personalized cooking guidance.

The NLP pipeline begins with input processing, converting voice inputs to text using speech recognition. Text inputs can be processed through either: (1) a rule-based system utilizing regex patterns and decision trees for intent classification; (2) an API-based system leveraging third party services with cooking domain context; or (3) a custom transformer-based model fine-tuned on cooking-specific data.

The multi-recipe scheduler implements a novel constraint satisfaction algorithm, generating dependency graphs and optimizing parallel execution while managing shared kitchen resources. The scheduler works backwards from target completion times, applying critical path analysis to identify optimal step interleaving.

The adaptive learning system combines collaborative filtering with reinforcement learning, tracking user behavior patterns, recipe preferences, and skill progression. Batch processing updates refine personalization models based on aggregated user data.

The system thus includes the following features. Dynamic Multi-Recipe Coordination System. Dependency graph generation for multiple simultaneous recipes. Resource conflict resolution with user confirmation. Real-time schedule optimization with parallel step identification. Adaptive Learning Architecture. Hybrid approach combining collaborative filtering and reinforcement learning. Batch processing for preference model updates. Context-aware instruction complexity adjustment. Multi-Modal NLP Processing. Three-embodiment architecture for scalable implementation. Cooking domain-specific context integration. Seamless transition between rule-based, API-based, and custom model approaches Intelligent Output Generation. Context-switching for multi-recipe guidance. Timer-based alert system with predictive notifications. Dynamic instruction adaptation based on user progress.

Scalability Considerations: Rule-based system for initial deployment. API integration for enhanced capabilities. Custom model for full feature set. Data Privacy: User data stored locally with opt-in cloud sync. Batch processing maintains anonymity. Federated learning potential for future iterations. Performance Metrics: Intent classification accuracy >95%. Schedule optimization <100 ms o Real-time response generation <500 ms.

```
ALGORITHM SPECIFICATIONS
Multi-Recipe Scheduling Algorithm
Input:
Recipe set R = {r₁, r₂, ..., rₙ}
Target completion time T
Available resources K = {oven, burner₁, burner₂, ..., burnerₘ}
User skill level S
Process:
1. FOR each recipe r in R:
Parse recipe into steps Sᵣ = {s₁, s₂, ..., sₖ}
Extract step dependencies Dᵣ
Identify resource requirements Rᵣ
Calculate active/passive time for each step
2. Generate Master Dependency Graph G:
Create nodes for each step across all recipes
Add edges for intra-recipe dependencies
Add edges for resource conflicts
Annotate with time requirements
3. Apply Scheduling Algorithm:
Work backwards from target time T
Use critical path method to identify longest chains
Identify parallel execution opportunities
Check resource availability constraints
Generate time-slot matrix M
4. Optimize Schedule:
Minimize idle time
Maximize parallel execution
Ensure resource conflicts are resolved
Add buffer time based on skill level S.
5. Validate Schedule:
  IF conflicts exist:
    Adjust timing or suggest alternatives ELSE:
    Proceed with schedule
Output:
Optimized cooking schedule with interleaved steps
Resource allocation timeline
Critical timing alerts
3.2 Adaptive Learning Algorithm Input:
User interaction history H
Recipe completion data C
User ratings R
Substitution patterns S
Process:
1. Statistical Tracking:
Calculate recipe frequency matrix
Track average completion times per step
Identify substitution patterns
Compute success rates
2. Collaborative Filtering:
Generate user feature vector Vᵤ
Cluster users by cooking patterns
Apply matrix factorization
Generate recommendation scores
3. Reinforcement Learning Update:
Define state space: S = {user_profile, recipe_context, time_constraints}
Define actions: A = {recommend_recipe, adjust_timing, modify_complexity}
Calculate reward: R = α(rating) + β(completion) + γ(repeat_cooking)
Update Q-values using Q-learning algorithm
Apply exploration/exploitation strategy
4. Batch Processing Update:
Aggregate user data over time window
Retrain preference models
Update user clusters
Refine recommendation weights.
Output:
Personalized recipe recommendations
Adjusted timing estimates
Complexity-adapted instructions
3.3 Natural Language Processing Pipeline
Embodiment 1 - Rule-Based:
Tokenize input text;
Apply regex patterns for action words
Match against recipe/ingredient database
Extract intent using decision tree
Return structured command object
Embodiment 2 - API-Based:
Format input with domain context:
context = {
“domain”: “cooking_assistant”,
    “session_state”: current_state,
    “user_query”: input_text
  }
Send to third-party NLP API
Parse response for intent and entities
Map to internal recipe database
Generate cooking-specific response
Embodiment 3 - Custom Model:
Preprocess input using cooking-specific tokenizer
Apply BERT-based encoder
Use fine-tuned classification head for intent
Apply NER model for entity extraction
Post-process with cooking domain rules
```

A computer, as referred to herein refers to a mobile device, a notebook or laptop computer, a desktop computer, or the like. A mobile device generally refers to a smartphone, a tablet computer, a smart watch, or other wearable, or the like. A notebook computer is used in its ordinary sense and includes laptop computers and other portable computing devices. A desktop computer is used in its ordinary sense and includes standard desktop computing devices.

The invention can thus be computer implemented in digital electronic circuitry, or in computer hardware, firmware, software, or in one or more combinations thereof. The invention can be implemented in a computer program product tangibly embodied in a machine-readable storage device for execution by a programmable processor; and method steps in the invention can be performed by a programmable processor execution a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and optical disks. Any of the foregoing can be supplemented by, or incorporated in, ASICs (application-specific integrated circuits).

A computer system as contemplated herein can include a bus, a processor, a system memory, a read-only memory, a permanent storage device, input devices, and output devices. In some embodiments, the computer system also includes a graphic processing unit (GPU). The bus collectively represents all system, peripheral, and chipset buses that support communication among internal devices of the computer system. For instance, the bus communicatively connects the processor with read-only memory, system memory, and a permanent storage device.

From these various memory units, the processor (also referred to as a central processing unit or CPU) retrieves instructions to execute and data to process in order to execute the processes of the invention. Read-only-memory (ROM) stores static data and instructions that are needed by the processor and other modules of the computer system.

A permanent storage device is a read-and-write memory device. This device is a non-volatile memory unit that stores instruction and data even when the computer system is off. Some embodiments of the invention use a mass-storage device (such as a magnetic or optical disk and its corresponding disk drive) as a permanent storage device. The permanent storage device may be a solid-state storage, a conventional “spinning magnetic pallet” storage (i.e., hard drive), or combinations thereof. Other embodiments may use a removable storage device (such as a USB flash drive or SD Memory Card) as a temporary storage or as the permanent storage device.

System memory is a read and write memory device. The system memory can be a volatile read-and-write memory, such as a random-access memory. The system memory stores at least some of the instructions and data that the processor needs at runtime.

Instructions and/or data needed to perform processes of some embodiments are stored in the system memory, the permanent storage device, the read-only memory, or any combination. For example, the various memory units may contain instructions for processing multimedia items in accordance with some embodiments. From these various memory units, the processor retrieves instructions to execute and data to process in order to execute the processes of some embodiments.

The bus also connects to input and output devices. The input devices enable the user to communicate information and select commands to the computer system. The input devices include, but are not limited to, alphanumeric keyboards, touch panels, cursor controllers and voice command or instruction input. Voice input can include voice commands or instructions input through artificial intelligence (AI) and AI agents and the like. The input devices also include scanners through which an image can be input to the computer system. The output devices display images generated by the computer system. The output devices may include display devices including touch display, such as liquid crystal displays (LCD), light emitting diode (LED), organic light emitting diode (OLED), active matrix organic light emitting diode (AMOLED), electroluminescent displays, cathode ray tubes (CRT), as well as printers, pen plotters, laser printers, ink-jet plotters, and film recorders. More specifically, this includes output displays including state-of-the-art displays and touch displays on cell phones, tablets, laptops and notebook computers, and desktop computers.

Bus can also couple a computer to a network through a network adapter. In this manner, the computer can be a part of a network of computers (such as a local area network (“LAN”), a wide area network (“WAN”), or an Intranet) or a network of networks (such as the Internet). Finally, the computer system in some embodiments also optionally includes a graphics processing unit (GPU). A GPU (also referred to as a visual processing unit or a display processor) is a dedicated graphics rendering device which is very efficient in manipulating and displaying computer graphics. The GPU can be included in a video card or can be integrated into the mother board of the computer system along with the processor. Any or all the components of computer system may be used in conjunction with the invention. However, one of ordinary skill in the art will appreciate that other system configurations may also be used in conjunction with the invention.

### Glossary

User profile information as referred to herein refers to user information such as name, address, country, age, sex, and cooking experience. Other user preferences related to cooking are also contemplated such as preferred types of food and cooking techniques, dietary restrictions/needs and allergies, and the like.

Recipes as referred to herein refer to cooking recipes that can be found in cookbooks, cooking websites, blogs, and the like.

Kitchen resources refer to cooking appliances, cooking equipment, pots and pans, utensils, and the like that is available in the user's kitchen. This would normally include stoves and ovens, microwave ovens, grills, broilers, and other cooking equipment that is well known in the art and included in a home kitchen or in a commercial or restaurant setting.

Time constraints include cooking times involved in the preparation of a recipe including heating times, cooling times, and the like. Time constraints can also include variables such as an end time when a particular recipe or dish should be completed.

Cooking guidance refers to active computer guidance provided from the computer providing all aspects of the preparation of a recipe starting with an ingredient list to step by step cooking instructions. The cooking guidance can be provided preferably in the form of voice instructions or text. The guidance can be interactive with the user. The user can thus make interactive changes to the preparation of a recipe while in progress; modifying ingredients, cooking times, making additions, and the like. The cooking guidance can also provide guidance for a plurality of recipes at once, for example, for 2, 3, 4, 5, or up to 10, or more recipes at one time. The guidance can be coordinated, for example, coordinating the cooking times for each recipe to provide the completed food product at the same time or according to a predetermined schedule.

The cooking guidance can also adapt to a user using machine learning as described elsewhere herein. That is, adapt to user food preferences, for example with regard to spices and other cooking preferences, user cooking experience level, and the like.

While this disclosure includes specific examples, it will be apparent after an understanding of the disclosure of this application has been attained that various changes in form and details may be made in these examples without departing from the spirit and scope of the claims and their equivalents.

1. A computer Implemented method for providing real time cooking guidance to a user for one or a plurality of cooking recipes comprising:
providing voice input or text input information to the computer from the user, wherein the voice input is converted to text input with a natural language processor; and the voice input or text input information to the computer comprises the following:
user profile information;
recipe selection;
kitchen resources;
ingredients; and
number of servings; and
providing recipe guidance by the computer for the one or more recipes comprising providing a recipe ingredients list, and step by step cooking instructions to the user for the one or more recipes.

2. The method of claim 1, wherein the voice input or text input information to the computer further comprises time constraints.

3. The method of claim 2, wherein the step by step cooking instructions comprises time constraints and reminders.

4. The method of claim 1, wherein if an ingredient from the ingredients list is not available, the recipe guidance suggests alternative ingredients.

5. The method of claim 1, wherein the recipe guidance is provided interactively with the user.

6. The method of claim 1, wherein the recipe guidance comprises the plurality of recipes and further provides coordinated recipe guidance configured to provide for the coordinated cooking of the plurality of recipes simultaneously.

7. The method of claim 6, wherein the coordinated recipe guidance is configured for the recipes to be completed according to a predetermined schedule.

8. The method of claim 1, wherein the recipe guidance comprises adaptive learning that comprises machine learning that is configured to adapt the recipe guidance to previous interactions with the user.

9. The method of claim 1, wherein the recipe guidance is configured to adapt to the user's experience level provided in the user profile.
